(19) United States
(12) Patent Application Publication
(10) Pub. No.: US 2025/0054519 A1
(43) Pub. Date: Feb. 13, 2025

(54) METHOD FOR AUTOMATIC MEDIA EDITING

(71) Applicants: Gary Hustwit, Saugerties, NY (US); Brendan Dawes, Saugerties, NY (US)

(72) Inventors: Gary Hustwit, Saugerties, NY (US); Brendan Dawes, Saugerties, NY (US)

(21) Appl. No.: 18/801,016

(22) Filed: Aug. 12, 2024

Related U.S. Application Data
(60) Provisional application No. 63/519,024, filed on Aug. 11, 2023.
(60) Provisional application No. 63/664,069, filed on Jun. 25, 2024.

(51) Int. Cl. G11B 27/036; G11B 27/10

(52) U.S. Cl. CPC G11B 27/036; G11B 27/10

(57) ABSTRACT

Variants of the method can include: determining media files, optionally tagging a subset of the media files, determining generation parameters, amending the timeline according to the generation parameters, and/or optionally rendering the timeline. The method functions to automatically generate temporally continuous media content from a set of media clips. The usage of both tags and a set of parameter timelines enables the method to generate films which exhibit generative drift with respect to tags while maintaining overall control of the arc of the film.

### CROSS-REFERENCE TO RELATED APPLICATIONS

This application claims the benefit of U.S. Provisional Application No. 63/519,024 filed 11 Aug. 2023 and U.S. Provisional Application No. 63/664,069 filed 25 Jun. 2024 each of which is incorporated in its entirety by this reference.

### TECHNICAL FIELD

This invention relates generally to the media generation field, and more specifically to a new and useful method in the media generation field.

### BRIEF DESCRIPTION OF THE FIGURES

FIG. 1 is a schematic representation of a variant of the system.

FIG. 2 is an illustrative example of a variant of a user interface for a program operating according to the method.

FIG. 3 is an illustrative example of a variant where weights are linked to different effects.

FIG. 4 is a schematic representation of a variant of S410 and S420.

FIGS. 5A-5D are illustrative examples of variants of parameter timelines.

FIG. 6 is an illustrative example of a variant of media files and tags.

### DETAILED DESCRIPTION

The following description of the embodiments of the invention is not intended to limit the invention to these embodiments, but rather to enable any person skilled in the art to make and use this invention.

### 1. Overview

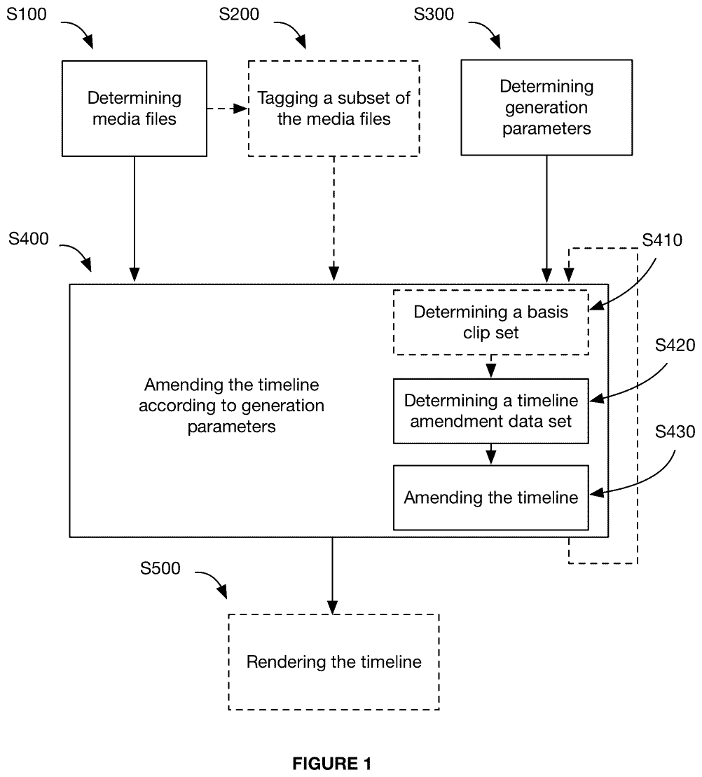

As shown in FIG. 1, variants of the method can include: determining media files S100, optionally tagging a subset of the media files S200, determining generation parameters S300, amending the timeline according to the generation parameters S400, and/or optionally rendering the timeline S500. The method functions to automatically generate temporally continuous media content from a set of media clips.

### 2. Examples

In an illustrative example, the method can include storing user-selected media in a file storage system, receiving information about tags assigned to each media (e.g., “cat” describes a clip containing a cat, and “injury” describes a clip of a character receiving an injury; other tags may relate to other concepts), and/or determining user-defined generation parameters and/or parameter timelines defining method operation. During a timeline editing process (e.g., wherein the timeline 100 is a data structure containing references to sequentially-arranged clips within discrete tracks), the method can include determining a basis clip set 11 made up of clips near the end of the timeline 100, determining a timeline amendment data set 12 made up of clips with a user-defined number of tags matching tags in the basis clip set 11, and/or amending the timeline 100 by adding a clip made of cropped data from a media file from the time amendment data which is cropped according to a generation parameter (e.g. a minimum percentage threshold for clip length, or some other generation parameter). Once the timeline 100 is amended, S430 may repeat using the recently added clips as the basis clip set 11 of the next iteration, and/or the method may finish with a rendering of the timeline 100 according to the clips and their relationships in the timeline 100 (e.g., to produce a video clip).

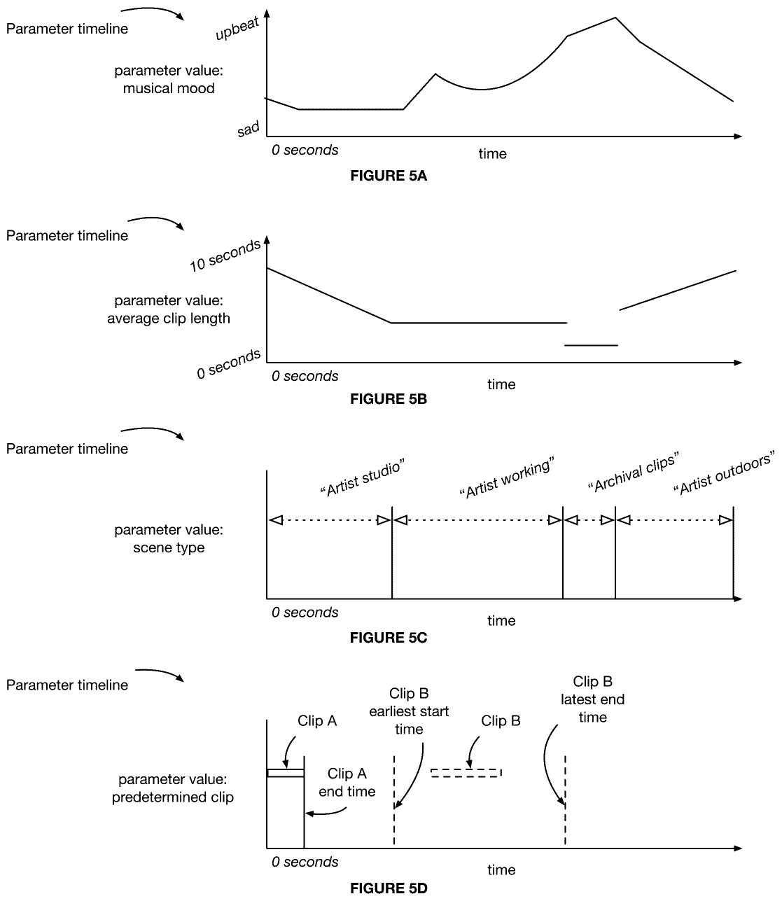

In an illustrative example, the method selects an amendment data set 12 and amends the timeline 100 based on a combination of tags from prior clips (e.g., a basis clip set 11) and a parameter timeline, which defines how generation parameters change over time. The usage of tags from prior clips can result in the amendment data set 12 containing locally-relevant clips (e.g., for continuity), and the usage of the parameter timeline can result in the amendment data set 12 matching a predetermined trajectory of characteristics of the film (e.g., the tone of music changing according to a predetermined pattern, e.g., example shown in FIG. 5A, etc.). The combination of both tags and a set of parameter timelines enables the method to generate films which exhibit generative drift with respect to tags while maintaining overall control of the arc of the film.

### 3. Technical Advantages

Variants of the technology can confer one or more advantages over conventional technologies.

First, by automatically generating films or portions of films, the method enables rapid generation of a film from raw data. This is advantageous because it saves editors time and energy which would otherwise be spent dragging clips into an editor to test how well they fit.

Second, by automatically selecting a candidate amendment data set 12 from a file memory, the method enables automatic identification of an optimal or near-optimal clip according to some metric. If a file set is large (for example, a file set containing days' worth of security camera data), selecting clips may take days. The method could shorten the process to seconds.

Third, by using generation parameters (e.g., defined by parameter timelines, etc.) to guide the editing process, the method enables more sophisticated films to be created than a random clip combining algorithm. This improves the quality of the output (e.g., generated film). A higher-quality film (i.e., with fewer plot holes and more coherent dialogue and plot) is more commercially viable than a lower quality one, and the use of a processing system to create one saves time and money when compared to a human editor. Additionally, generation parameters can optionally be time-dependent (e.g., in a parameter timeline), enabling a user to define how parameters defining characteristics of a film to change over time. This can enable the user to define an arc for each generation parameter (e.g., tone, action, music, etc.), thus enabling a computer system without a human intuition to mimic a story arc. Additionally, the usage of generation parameters enables legibility of the film generation process to a user and/or other computing system performing the method.

Fourth, by optionally offering the user the ability to provide input at each part of the film generation process, the film generation process can be stopped or re- attempted when an added set of clips is low-quality. In some variants, the user can iteratively approve each amendment to the film. This allows the user to overcome some of the shortcomings of using a computer to make creative decisions-the user can simply override them and allow the computer to make creative decisions which the computer is better-equipped for (for example, quickly identifying a set of clips containing information relating to a specific tag and using a neural network to identify the best clip to use for a given scene). This improves the quality of the output.

Fifth, the usage of a basis clip set 11 (e.g., determining next clips based on recent clips in the timeline 100) enables the system to exhibit drift (e.g., “genetic drift” where tags are analogous to genes, etc.) as an emergent property. This enables a film to be generated which diverges from an original generation parameter set (e.g., a user defined generation parameter set) while maintaining relative local continuity (e.g., between successive clips) throughout the film. This can cause a generated film to exhibit properties not conceived of by a human filmmaker without using computationally costly machine learning models. Thus, a heuristic approach described in variants of the method can enable a quickly-generated film to exhibit properties present in films generated through machine learning-based generative methods.

Sixth, the usage of a parameter timeline enables a user to constrain certain generation parameters (e.g., tags, clip selection parameters, etc.) to a trajectory (e.g., a predetermined trajectory, dynamically-determined trajectory based on audience information, etc.). This enables the method to generate films which adhere to user-determined principles in some respects while allowing the film generation process to be “free” in other ways (e.g., to “genetically drift”). This can enable enabling varying degrees of control of different aspects of the film. Additionally, this enables different parts of the same film to be generated using different generation parameters, eliminating the need to split a film generation process into distinct parts in order to generate a film which exhibits parameter variation over time.

However, further advantages can be provided by the method disclosed herein.

### 4. Method

As shown in FIG. 1, variants of the method can include: determining media files S100, optionally tagging a subset of the media files S200, determining generation parameters S300, amending the timeline 100 according to generation parameters, and/or optionally rendering the timeline S500. The method functions to automatically generate temporally continuous media content from a set of media clips. The method can operate continuously (constantly adding clips to the timeline 100 and rendering them) or it can operate at one time, producing a single video file upon completion. In a specific example, when operating continuously, the method can generate a never-ending video while playing the video. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

In a specific example, the method can include determining a set of generation parameters; selecting a subset of media clips from a first set of media clips arranged within a media timeline, wherein the subset of media clips are associated with a set of first tags; selecting a set of amendment media clips from a set of media files separate from the timeline, comprising, for each stored media file within the set of stored media files: extracting a set of second tags associated with the respective stored media file; determining a tag overlap between the set of second tags and the set of first tags; and responsive to the tag overlap exceeding a threshold value specified by the generation parameters: generating a new media clip from the respective stored media file; and adding the new media clip to the set of amendment media clips; adding the set of amendment media clips to the media timeline; and repeating steps a)-d) using the set of amendment media clips added to the media timeline as part of the subset of media clips. However, the method can be alternatively be performed.

Determining media files S100 functions to determine a dataset containing usable media files. The dataset can include video files, image files, audio files, gifs, effect files, and files of other types. Examples of file types include .MP4, .GIF, .MOV, .WAV, .MP3, .JP3, .PRFPSET, .FFX, .AVI, and/or any other suitable file type. The media files are stored in a file memory, which may be local or cloud-based. The file memory can be read-only, read-write, or have any suitable type of access permissions. The media files can each include a set of user-defined weights. In variants, the user-defined weights can serve as a weight for a media file given a certain context, given a film theme, given a preceding clip, given a preceding scene, given a desired plot arc, any other suitable prior information, and/or no prior information.

Determining media files S100 functions to determine a set of smeedia files. S100 can be performed by the processing system running the overall method, can be performed locally, can be performed remotely, and/or can be performed by any other entity or third party.

The set of media files can be determined by selecting a subset from a larger dataset, receiving files from an external source (which can include a camera, computer memory, image generation software, or some other external source), another software application on a device, can be generated on the processor running the method, can be determined through some other method, or can be determined through some combination of methods. Media files can be received online or offline or can otherwise be received. Preferably, media files are stored locally but can alternatively be stored on a cloud.

In a variant, media files already within the file memory can be selected by a user via a user interface 200.

In a second variant, media files can be automatically selected based on their content, metadata, or other attributes (e.g., user-defined weights). Media files can be selected according to a generation parameters and stored in a file memory, wherein the generation parameters can select files which relate to a theme, media files which were captured (e.g. recorded, downloaded, etc.) within a specific timeframe, media files which can be accessed from a specific website, folder, third party, or other entity, media files which are received via some means of communication or protocol (e.g. received by email, AirDrop, Bluetooth, HTTPS, or another means), or files which meet some criteria defined by the user in S300.

In a third variant, media files can be procedurally generated. In this variant, media files can be generated locally, remotely, or in any other location. Media files can be generated responsive to a user prompt or can be already existing. In an example, media files can be generated from clips of other files combined in some way (e.g., concatenated, overlayed, merged with a transition, etc.). In a second example, media files can be generated by a neural network with any architecture (e.g., a GAN, VAE, CGAN, or any other suitable architecture). In an embodiment of this example, media files are generated according to prompts (user-generated or automatically generated).

Optionally tagging a subset of the media files S200 functions to associate each media file with a set of tags describing the file. A tag can be text, a hash, or some other data type associated with a media file or set of media files. Tags can describe the content of the media file, some characteristic of the media file (e.g., a tone of the media file, a plot element represented in the media file, a parameter for how the media file can be used in the method, and/or any other suitable characteristic for description. All, some, or no media files can be tagged. Tags can be amended, added, and removed at any point during the method. Media files can have multiple tags, tags can override previously assigned tags, and/or media files can have no tags. Examples of tags include lyrics, character names, colors, locations, capture times, storyline, quotes, environmental characteristics, emotional tone, time of creation, whether music is playing, musical tone, and/or any other quality of a media file. Media files can be tagged based on an audience-specific tag profile (e.g., where different audiences may consider different clips “funny” or “sad”) or a general tag profile (e.g., a mixture of preferences from multiple different potential audience members).

In an embodiment of this variant, tags can be determined by a user. Tag determination can be facilitated by the program running the method or tags can be determined at a previous or concurrent time and imported into this method. Tags can be user-determined by any method.

In a second embodiment of this variant, tags can be automatically determined. Tags can be automatically determined within the program running the method or previously or concurrently with another automatic tagging program running locally or remotely. Tags can be automatically determined by a tagging model. A tagging model can be a convolutional neural network (CNN), recurrent neural network (RNN), Long Short-Term Memory (LSTM), transformer model, two-stream network (e.g., wherein visual and temporal information are processed separately), 3D convolutional network, multimodal model, and/or any other suitable type of model. In this embodiment, the tagging model can be trained on user-tagged videos, videos tagged based on audience information (e.g., live audience information), and/or any other suitable type of training data. In an example, live audience information is used to refine the tagging model.

Tags for a media file can be stored within the metadata of a media file, within the media file itself, or in a separate tag file containing a set of media file-tag couplings. In the embodiment where tags are stored in a separate tag file, the tag file can be a CSV, TXL, XLSX, JSON, or any other suitable data type. In this embodiment, the tag file can be stored locally or remotely and can be accessible or partially accessible by other entities. Alternatively, the tags can be stored by a tag-storing application which sends tags responses to tag requests. The file storing tags can store a media file, media file hash, media file name, media file address, or some other data to represent the media file attached to a tag. The tag file can be organized tag-first, with media file references attached to each tag or media file-first, with tags attached to each media file. Tags can optionally include user-defined weights. The tag file can be otherwise organized.

Determining generation parameters S300 functions to determine parameters which affect the characteristic of assembled clips. Generation parameters may refer how basis clips should be selected in S410 (e.g., tags of clips to be selected or to not be selected, tag conditions for clip selection), how the amendment data set 12 should be determined in S420 (e.g., parameters defining the conditions of the basis clip set 11, parameter timeline, stored media files and/or tags thereof), how media files from the amendment data set 12 should be added to the timeline 100 in S430 (e.g., selecting a subset of the amendment data set 12, determining an ordering of media files within the amendment data set 12, etc.), how selected clips should be edited prior to being added to the timeline 100 in S430 (e.g., how to form clips from media files, for example, average clip length given other tags of the media file, etc.), and/or how another suitable method should be performed. Examples of generation parameters include minimum and/or maximum tag overlap with tags from a basis clip set 11, weights corresponding to the importance of different tags for selection, film runtime, film tone, clip minimum and maximum length, film storyline, clip quality and quantity, brightness, color scheme, theme, and any other suitable parameter. Generation parameters can be binary (e.g., “include music,” etc.), scalar (e.g., volume), categorical (“action”, “drama”, etc.) or can be any other type. Generation parameters can be added, removed, or edited at any point during the method. Updating of generation parameters can result in the method repeating S200, S300, S400, and/or S500. Generation parameters may be selected for the film, sections of the film, or for specific clips. Generation parameters may affect the likelihood of different effects, generation may dictate clip qualities (for example, reducing the volume of background music for the length of a dialogue clip when it is added), generation parameters may prevent certain types of clip combinations, and/or generation parameters can have any other suitable impact on the film. Generation parameters may additionally or alternatively affect any other quality of the film.

Generation parameters can be static or variable. In a variant, generation parameters can be time-based parameters defined by a parameter timeline (e.g., examples shown in FIGS. 5A-5D). In this variant, generation parameter values can change over time based on a current position in a parameter timeline. The parameter timeline can share a time metric (e.g., how time is calculated) with the timeline 100 but can alternatively use a different time metric. Examples of time metrics include time in seconds but can alternatively include time in terms of clip number (e.g., the number of clips in the timeline 100), a completion of predetermined plot elements, and/or any other suitable time metric. The parameter timeline can be manually determined (e.g., by a user via an interface) and/or automatically determined (e.g., based on user history, etc.).

In a first example of this variant, a parameter timeline can include generation parameters corresponding to overlapping or non-overlapping time windows within the parameter timeline (e.g., example shown in FIG. 5C). In embodiments of this example, only clips which include a particular tag and/or tags which are determined to be similar to the particular tag are selected for a given time window. In a second example of this variant, generation parameters can be defined by a function. In this example, the function can be a function of time, other generation parameters, and/or any other suitable values. In this example, the function can be a continuous function, piecewise function (e.g., example shown in FIG. 5B), a differentiable or non- differentiable function, and/or any other suitable type of function. In a third example of this variant, a parameter timeline can include a predetermined clip or set of clips for each of a set of time windows in which the clip should appear (e.g., example shown in FIG. 5D). In this example, the exact position of each clip can be predetermined (e.g., as in the case of Clip A) but can alternatively be merely constrained (e.g., as in the case of Clip B) and/or otherwise set. In a fourth example, the parameter timeline can include a trajectory through a multidimensional latent space, wherein the trajectory is a function of time (e.g., time within the parameter timeline). In this embodiment, clips can be selected based on a similarity (e.g., media file similarity, tag similarity, etc.) to the current position along the trajectory. In this embodiment, the latent space can be generated by training an encoder on clips (and/or tags thereof) from a different film, a global set of generic clips (e.g., from multiple films), from the set of stored media files, and/or any other suitable media. In an example of this variant, the trajectory can be defined by the encodings of clips and/or scenes of a different film, wherein the method functions to replicate parameters of the different film using stored media files overlapping or not overlapping with media files extracted from the different film. However, a parameter timeline can alternatively be used or not used to set generation parameters.

Generation parameters can be determined by a user and/or determined automatically. In a first variant, generation parameters are determined by a user. In a first example of this variant, a set of generation parameter options are displayed to a user and selected based on user input. In a second example of this variant, a set of generation parameters are input by the user via a user interface 200. In a third example of this variant, a set of structured or unstructured text prompts are input by the user.

In a second variant, generation parameters are automatically determined. In an example of this variant, generation parameters are selected based on a user history. The user history can be a set of user-preferred tags input by the user, a set of generation parameters and/or aggregate (e.g., averaged) set of generation parameters corresponding to films watched, a set of generation parameters and/or aggregate set of generation parameters corresponding to films which the user gave a score above a threshold value, and/or any other suitable type of user history. In a second example, generation parameters are time-based parameters within an existing parameter timeline, wherein the generation parameters are determined based on prior parameters in the parameter timeline (e.g., using any of the methods used in S400, but applied to generation parameters instead of media files). In an embodiment, parameters can be gradually adjusted over time so that the film doesn't change properties (e.g., tone, clip length, etc.) too quickly. In a second embodiment, generation parameters are automatically determined based on prior generation parameters in the parameter timeline and a user history (e.g., to match the generation parameter change patterns of films watched and/or liked by the user; to match a user-input generation parameter change pattern, etc.). In a third embodiment, a parameter timeline for an existing film is extracted from the existing film (e.g., using a machine learning model and/or set of machine learning models trained to extract tags and/or generation parameters), and a new film is generated using the set of media files and the parameter timeline for the existing film. In this embodiment, the set of media files can be the same media files used to generate the existing film, can overlap with the media files used to generate the existing film, and/or can be separate and distinct from the media files used to generate the existing film. In a specific example of this embodiment, the extracted parameter timeline can be amended before being used to generate a new film.

In a third variant, generation parameters are determined alongside the media files, wherein both generation parameters and media files are received in a dataset from a third party source or from another computer memory or application.

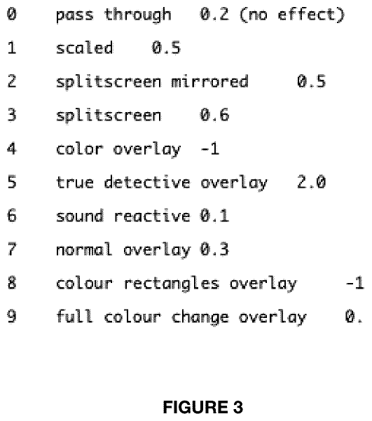

In a fourth variant, a parameter package or file containing generation parameters is received from another application, another computer memory, or from another source independently of the media files. In a specific example, a set of effects which can be applied to the content (such as split screen, color overlay, slow motion, etc.) are each weighted by the user based on a preference score between o and 1, where a score of “1” means the respective effect is more likely to occur than a score of “0.1”. A score of −1 means this effect cannot occur. (e.g., example shown in FIG. 3). The likelihood of effects can also be affected by context. For example, a “reduce music volume” effect can be highly likely when a voiceover track is added to a contemporaneous position on a parallel track.

In a fifth variant, generation parameters are randomly determined.

However, generation parameters can be determined by any other suitable method.

However, determining generation parameters S300 can be otherwise performed.

Amending the timeline according to generation parameters S400 functions to generate or amend a sequence of tracks in a track-based timeline 100. At the beginning of this S400, the timeline 100 can be empty or can contain tracks, and the tracks can be empty or contain clips. S400 can be performed responsive to user input, can be automatically prompted, can occur on a timed basis, or can be otherwise executed. It can be performed once or on a recurring basis, and it can be halted at any time responsive to user input. S400 can include determining a basis clip set S410, Determining a timeline amendment data set S420, and/or amending the timeline S430.

Optionally determining a basis clip set S410 functions to select a subset of clips already in the timeline 100 to use as inputs to inform which media files should be added to the timeline 100 as clips. In the variant in which the timeline 100 is empty during S400, S410 is not performed or is performed on a set of clips or media files not in the timeline 100. The basis clip set 11 can be selected directly by the user, automatically, or can be previously determined or determined by anther program or third party. In a preferred embodiment, the basis clip set 11 is the most recent X clips in the timeline 100, where X is a previously determined constant generation parameter or is determined by the user during S410, and X can be the number of clips in the timeline 100. In a specific example, the basis clip set is selected based on a proximity of each clip to a current temporal position within the timeline 100. The current temporal position can be the end of the last clip within the timeline 100, the end of the last clip in a basis clip set from a prior iteration of the method, a position of a user selection element (e.g., a mouse), the current temporal position of a film being currently played (e.g., a film generated from clips in the timeline, a temporal position before or after any of the aforementioned positions, and/or any other suitable temporal position. The basis clip set 11 can include file names and/or metadata of the media files referenced by each clip, can include a copy of the media file (e.g., edited according to edits made in the timeline 100 or unedited), and/or can include some other reference to the media. The basis clip set 11 can additionally include metadata relating to how each clip relates to other clips within and outside of the basis clip set 11. The basis clip set 11 can optionally include a rendered film clip from S500 determined using clips within the data set. The basis clip set 11 can optionally include tags and other metadata relating to clips within the data set, the set as a whole, and/or the film as a whole. The basis clip set 11 can be determined based on a set of generation parameters for the overall performance. In a first variant, a generation parameter refers to how quickly the performance should change moods. In this variant, when the generation parameter has a high value, the basis clip set 11 is smaller, thus increasing the likelihood of a clip of a highly different nature being selected in S420. In a second variant, a generation parameter refers to the basis on which a basis clip set 11 can be determined. In this variant, the generation parameter refers to the type of information which is most important to the performance (e.g., continuity of sound, continuity of plot, continuity of music, continuity of tags between successive clips, continuity of editing style, continuity of transition type, etc.) However, the basis clip set 11 can be otherwise determined based on generation parameters. Determining a basis clip set 11 can be performed according to any other suitable method.

Determining a timeline amendment data set S420 functions to determine the subset of media files which may be added to the timeline 100. S420 can include selecting subset of the media files selected in S100 according to some ruleset based on the generation parameters defined in S300 and optionally the tags defined in S200 and optionally the basis clip set 11 defined in S410. The amendment data set 12 can include media files, references to media files, references to a window of data within media files, or any data type. Selected media files can be individual media files, aggregated media files (e.g., compiled scenes), and/or any other suitable numbering and/or arrangement of media files. In a first variant, the amendment data set 12 is a set of individual media files. In a second variant, the amendment data set 12 includes media files selected from a selected grouping of media files (e.g., media files in a user-generated grouping, media files in an existing scene, etc.). In a third variant, the amendment data set 12 includes media files within a separate timeline 100 (e.g., a timeline 100 representing a user-generated scene). In this variant, the amendment data set 12 can be all of the media files (e.g., extracted from clips, etc.) in the separate timeline 100 or a subset of media files in the separate timeline. However, the amendment data set 12 can be determined in any other suitable grouping.

In variants, the amendment data set 12 can optionally be selected based on live audience information (e.g., determined by a system playing the video file or another suitable system). The system determining audience information can be the same system playing the video file determined from the timeline 100, can be in communication with the system playing the video file, can be disconnected from the audience, and/or can be otherwise related to the audience. In an example, the stream of the video is sent from a local processing system to a remote processing system, and audience information is dynamically received from the remote processing system. Audience information can be predicted (e.g., based on manually-input information about audience trends, based on temporal data, based on location data, based on ticket sales data, etc.), measured (e.g., based on audience count, audio data capturing audience noise, etc.), calculated (e.g., estimating sentiment based on audio data captured for an audience, based on demographic information of a set of audience members, etc.), received (e.g., from a user within a theater, directly from the audience member themselves, etc.), and/or otherwise determined. In variants where the audience information is received directly from the audience, the audience member can provide active or passive live feedback. Examples of active live feedback include selections (e.g., from an onscreen button, list, etc.), voice commands (e.g., captured by a laptop microphone, in-room microphone, etc.), eye-tracking commands, hand signals, and/or other forms of active live feedback. Examples of passive feedback include eyelid droopiness analysis, gaze analysis (e.g., identifying when an audience member is looking away from the video, or identifying when an audience member is looking at non-important elements within a video clip), yawn detection, audience presence detection, and/or any other suitable form of passive feedback. Live audience information can be determined based on measurements captured by the system playing the video or another suitable system in communication with the system playing the video. Examples of sensors which can facilitate determination of live information include cameras, depth sensors, heat cameras, microphones, a computer keyboard, computer mouse, computer trackpad, and/or another suitable type of sensor. Examples of computing components which can facilitate determination of audience information include machine learning models (e.g., video analysis models, frame analysis models, language models, chatbots, etc.). However, live audience information can be otherwise determined.

The amendment data set 12 can additionally or alternatively be selected based on a desired audience reaction. A desired audience reaction can represent an emotional reaction (e.g., a change in mood) and/or a physical reaction (e.g., applause, laughter). A desired audience reaction can be selected by a subset of the audience before or during the video being played (e.g., as a form of live feedback), can be selected by a theater operator (e.g., via a control interface, can be selected by a remote controlling entity (e.g., a person or an autonomous bot providing creative control), a different audience, a prior audience (e.g., wherein the selection of media files improves over time based on audience feedback during or after the performance of the video), and/or another suitable entity. The desired audience reaction can be set as a target reaction (e.g., laughter above a certain number of decibels), a target reaction rate of change (e.g., increasing or decreasing a particular measured type of reaction), a desired reaction magnitude (e.g., where the type of reaction is not determined but the intensity of the reaction is), a desired reaction type (e.g., wherein the type of reaction is determined).

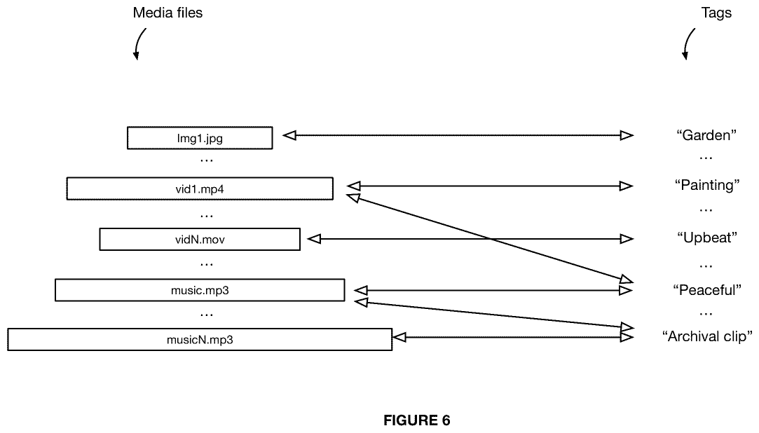

The desired audience reaction can optionally be a generation parameter. In this example, as with other generation parameters, the desired audience reaction can be a preset value, can be controlled as a function of time in a parameter timeline (e.g., example shown in FIG. 6), and/or can be otherwise characterized. The desired audience reaction can be determined deterministically or non-deterministically. Examples of deterministic determination of a desired audience reaction include a laughter decibel setpoint and/or a desired number of people to have in the theater. Examples of non-deterministic determination of a desired audience reaction include randomness or be input of a set of candidate audience reactions, of which a subset is randomly selected. However, a desired audience reaction can be otherwise selected. Selecting media files based on a desired audience reaction can be performed in a variety of ways. In a first variant, media files can be selected based on a tag being associated or matching the desired audience reaction. In this variant, media files can be selected based on a similarity of a tag to a desired reaction or based on another metric. In a second variant, media files can be selected based on their association with an audience reaction in a different iteration of the method being performed (e.g., a different performance). In this variant, media files associated with a reaction similar to the desired audience reaction can be selected, then a subset of the selected media files can be selected for use in the timeline 100. Alternatively, a media file associated with a known audience reaction (e.g., observed from the media clip being played) can be selected, and media clips each associated with an audience reaction can be selected based on similarity of the associated audience reaction and the known audience reaction. However, media files can be otherwise selected based on a desired audience reaction.

In a variant, media files are selected based on whether they contain similar tags to media files contained in the basis clip set 11. Similarity can be based on generation parameters (e.g., where generation parameters can include threshold percentage overlap, threshold number of overlapping tags, weights for determining tag overlap, and/or any other suitable generation parameters) and/or can be independent of generation parameters. In embodiments where generation parameters are used, generation parameters can be time dependent (e.g., according to a parameter timeline). In such embodiments, generation parameters can be a function of the current temporal position in the timeline (e.g., the position in the timeline based on which the basis clip set was determined, etc.).

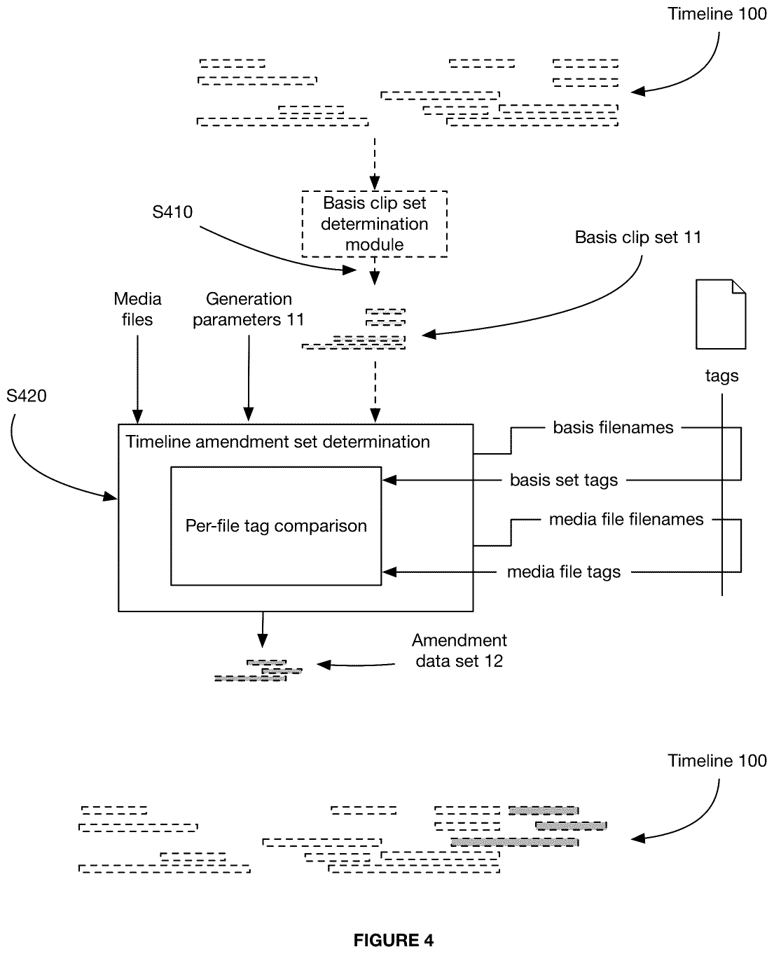

In a specific example of this variant, a generation parameter is a threshold number of matching media files are selected only if they contain at least a threshold number of matching tags with clips contained within the basis clip set 11 (e.g., example shown in FIG. 4). In this specific example, tags for basis file filenames are taken from the tag file and compared with tags for files within the media files, with tags also taken from the tag file. In a second variant, media files are selected according to whether they continue a pattern begun in the basis clip set 11. For example, a generation parameter may define that the film must contain alternating short clips and long clips. In a third variant, a neural network can be used to determine a set of media files. In a fourth variant, sections of media files are identified (e.g., wherein sections of media files have tags not associated with other sections of the respective media file), and the media files are edited to include only the sections of media files in the amendment data set 12. In a specific example, for each media file in the set of media files, S420 includes determining a current tag rule (e.g., comprising a generation parameter set which specifies types of tags which make an associated media file eligible) based on a current temporal position within the media timeline; and determining a clip eligibility of a media file based on the tags associated with the media file, a set of tags associated with the basis data set, and the current tag rule, wherein adding the media file to the set of amendment media clips is based on the clip eligibility and a tag overlap. However, S420 can additionally or alternatively be performed according to any other suitable method.

Amending the timeline S430 functions to add clips from the amendment data set 12 to tracks within the timeline 100, and/or optionally amend existing clips within the timeline 100. Picking the subset of clips to add to the timeline 100 from the amendment data set 12 can include duplicating the media files referenced in clips and storing them as a clip set or creating a clip set with references to media files in addition to clip start and end points relative to some timestamp within the media file. Amending the timeline 100 can optionally include adding transitions to the timeline 100.

In a variant, clips in the subset of clips are edited before or after being added to the timeline 100 (e.g., clipping, modifying volume, adding effects, modifying color distribution, modifying framerate, modifying speed, etc.) In an example, clips are edited by cropping it according to a random or user-defined percentage (e.g. 20% means that the clip is cropped such that its length is 20% of the length of the media file referenced by it). In a second example, clips within the subset of clips are edited concurrently (for example, to determine an auditory break in each clip whereby the transition between clips is aurally smooth). In a third example, clips within the subset of clips are edited in tandem with clips already on the timeline 100. In a fourth example, the processor replaces a clip in the timeline 100 with another clip of the same or different length.

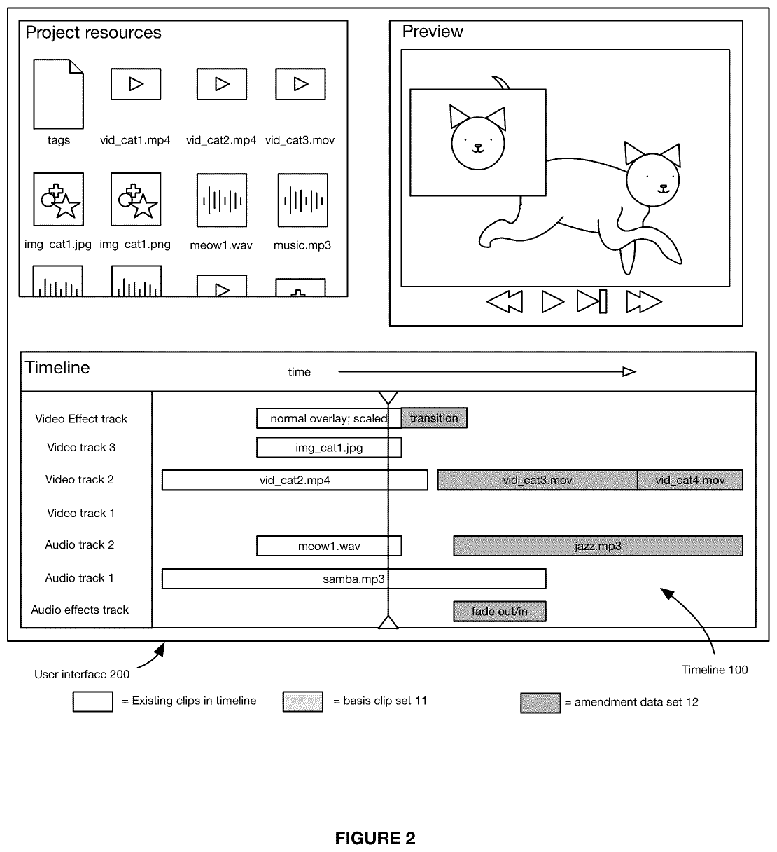

In a second variant, the processor adds a clip to a different track as an existing clip, where the added clip appears in addition to the clip in the existing clip track at a given time (for example, picture-in-picture or an overlay) (e.g., example shown in FIG. 2).

In a third variant, a transition effect is added an existing clip and a new clip (e.g., example shown in FIG. 2). A transition can be a cross-dissolve, zoom, jumpcut, fade, and/or any other suitable type of transition.

In a fourth variant, an existing video clip can be replaced with a different video, but the existing audio associated with the existing clip is kept and muted or removed.

In a fifth variant, no clips are added but an effect is added to an existing clip in the timeline 100.

In a sixth variant, the processor adds no clip from the amendment data set 12 to the timeline 100 and instead repeats S420.

However, the timeline can be otherwise amended.

The processor can optionally record which clips are in the timeline 100 so that at future iterations of S420 they are not reselected.

In a variant, S430 can be automatically performed multiple times with different clips within the timeline 100 and can present multiple options to the user. In a second variant, S430 can be performed on a subset of clips within the timeline 100. In an embodiment, the rendering of the subset of clips can be added to an amendment data set 12 in a next iteration of S420.

S430 can include adding new clips at the end of the last clip in the timeline, at the end of a last clip in a particular channel (e.g., where the end of the last clip in a channel is temporally earlier than the end of the last clip in the timeline), before clips in the basis clip set, overlapping with clips in the basis clip set, and/or after clips in the basis clip set. The position of new clips can be determined based on the temporal positions and/or lengths of clips in the timeline, clips in the basis clip set, and/or any other suitable temporal positions. In a specific example, S420 includes determining a temporal position in the media timeline which temporally overlaps a media clip within the timeline and/or basis data set and adding a clip of the set of amendment data set to the media timeline at the temporal position. However, S430 can include adding clips in any other suitable position.

Rendering the timeline S500 functions to determine a film file based on clips within the timeline. S500 can be performed responsive to a user command, responsive to a command from a remote computing system (e.g., a remote computing system to which the film file is being streamed, responsive to the timeline being amended (e.g., S430), and/or any other suitable condition. Rendering the timeline can include transmitting a stream (e.g., a stream containing elements of a film file) to remote computing system, amending an existing film file, generating a film file, and/or otherwise rendering the timeline. In variants where rendering the timeline includes transmitting a stream, the remote computing system can play the film file contemporaneously with receiving the film file and optionally determine a set of updated generation parameters during and/or after playing the film file. In a specific example where the set of updated generation parameters are determined during and/or after playing the film file, the updated generation parameters can be automatically determined based on audience information and a desired audience reaction, wherein the generation parameters are determined to have a high likelihood of changing an audience state from a state described in the audience information to an audience state described by the desired audience reaction.

Rendering the timeline can include determining a single film file (e.g., containing content from multiple channels of the timeline) and/or multiple film files (e.g., each containing content from a subset of channels of the timeline. Preferably the film file contains both audio and video but can alternatively not include both audio and video. In variants where the film file includes audio, cotemporal audio clips in the timeline are preferably overlaid on top of each other in the film file audio; however, a single audio clip can alternatively be chosen and used and/or the audio clips can otherwise be converted into the audio of a film file.

S500 is preferably performed concurrently and/or contemporaneously for multiple different remote processing systems at once (e.g., in variants of the method where multiple iterations of the method are being performed at the same time). In this variant, multiple streams with remote processing systems are open at the same time. In a specific example, a first timeline is amended (e.g., using methods described in S400) using a first set of generation parameters specific to a first remote processing system, and a first film file is rendered (e.g., generated) from the timeline. In this specific example, concurrently and/or contemporaneously with the first timeline being amended and/or the first film file being generated, a second timeline is amended (e.g., using methods described in S400) using a second set of generation parameters specific to a second remote processing system, and a second film file is rendered (e.g., generated) from the timeline. In this specific example, the first film file is rendered and/or transmitted to the first remote processing system contemporaneously and/or concurrently with the second film file being rendered and/or transmitted to the second remote processing system. In examples where multiple film files are generated at the same time (and/or substantially at the same time, e.g., contemporaneously), the multiple film files are preferably different from each other (e.g., contain different clips) but can alternatively overlap or be identical.

In variants, S500 can be performed before a next iteration of S400 (e.g., in variants where the film file is being dynamically rendered alongside adding clips to the timeline (e.g., S400). In a specific example, S500 includes rendering a film file from the media timeline, wherein the film file contains the amendment data set; transmitting the film file to a remote device configured to play the file, wherein the remote device plays the film file contemporaneously with receiving the film file and determines a new set of updated generation parameters (e.g., and/or adjusts an existing parameter timeline) during and/or after playing the film file, then transmits the updated generation parameters to a local computing system (e.g., the computing system running S400 & S500) which performs S400 using the updated generation parameters. In this specific example, the local computing system can use the updated generation parameters to generate a next film and/or next scenes for the film represented by the timeline.

However, rendering the timeline S500 can be otherwise performed.

In variants, the method can be performed iteratively (e.g., specifically S400 and/or S500 can be iteratively performed. In variants where the method is performed iteratively, the method can be performed until all media files within the set of media files (e.g., the set determined in S100) are used, until the cumulative length of the media files within the timeline reaches a particular threshold length (e.g., specified by a generation parameter), until the length of the film represented in the timeline reaches a particular threshold length (e.g., specified by a generation parameter), until a user instructs the local computing system to stop generating the film (e.g., via a user interface 200), until a remote computing system stops soliciting new additions to the film file, until a remote computing system sends a signal indicating that the an audience has stopped watching the film represented in the film file, until a remote computing system sends a signal that the audience has paused and/or stopped the film generation process manually, and/or responsive to any other suitable condition. The method can stop performing before all the media files within the set of media files are used, when all the media files within the set of media files, and/or after all the media files within the set of media files are used. In a specific example, the method can be performed iteratively until after the cumulative temporal length of clips in the media timeline exceeds the cumulative temporal length of the stored media files within the set of stored media files.

All or portions of the method can be performed by one or more components of the system, using a computing system, using a database (e.g., a system database, a third-party database, etc.), and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer- executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for automatic film generation, comprising:
a. determining a set of generation parameters;
b. selecting a subset of media clips from a first set of media clips arranged within a media timeline, wherein the subset of media clips are associated with a set of first tags;
c. selecting a set of amendment media clips from a set of stored media files separate from the timeline, comprising, for each stored media file within the set of stored media files:
extracting a set of second tags associated with the respective stored media file;
determining a tag overlap between the set of second tags and the set of first tags; and
responsive to the tag overlap exceeding a threshold value specified by the set of generation parameters:
generating a new media clip from the respective stored media file; and
adding the new media clip to the set of amendment media clips;
d. adding the set of amendment media clips to the media timeline; and
e. repeating steps a)-d) using the set of amendment media clips added to the media timeline as part of the subset of media clips.

2. The method of claim 1, further comprising:
compiling a film file from the media timeline comprising the added set of amendment media clips;
transmitting the film file to a remote device configured to play the film file;
receiving a set of updated generation parameters from the remote device; and
repeating b)-d) using the set of updated generation parameters as the set of generation parameters.

3. The method of claim 2, wherein the remote device is configured to:
play the film file contemporaneously with receiving the film file; and
determine the set of updated generation parameters after playing the film file.

4. The method of claim 1, wherein the subset of media clips are selected based on proximity to a current temporal position within the media timeline.

5. The method of claim 4, wherein the threshold value specified by the set of generation parameters is a function of the current temporal position.

6. The method of claim 4, wherein the set of generation parameters comprises a set of tag rules associated with a generation parameter timeline, wherein the set of tag rules vary with temporal position within the generation parameter timeline, and selecting the set of amendment media clips further comprises:
determining a current tag rule based on a current temporal position within the media timeline; and
determining a clip eligibility of the respective stored media file based on the current tag rule and the second set of tags, wherein adding the respective stored media file to the set of amendment media clips is based on the clip eligibility and the tag overlap.

7. The method of claim 1, wherein adding the set of amendment media clips to the timeline comprises:
determining a temporal position in the media timeline which temporally overlaps a media clip within the subset of media clips; and
adding a clip of the set of amendment media clips to the media timeline at the temporal position.

8. The method of claim 1, further comprising repeating step e) until after the cumulative temporal length of clips in the media timeline exceeds the cumulative temporal length of the stored media files within the set of stored media files.

9. The method of claim 1, further comprising:
establishing a connection with a first remote computing device;
establishing a connection with a second remote computing device; and
contemporaneously:
performing b)-d) using a first set of generation parameters specific to the first remote computing device as the set of generation parameters, wherein a first film file generated from the media timeline is transmitted to the first remote computing device; and
performing b)-d) using a second set of generation parameters specific to the second remote computing device as the set of generation parameters, wherein a second film file generated from the media timeline is transmitted to the second remote computing device.

10. The method of claim 9, wherein the first film file is distinct from the second film file.

11. A system comprising:
A processing system configured to:
a. determine a set of generation parameters;
b. select a subset of media clips from a first set of media clips arranged within a media timeline, wherein the subset of media clips are associated with a set of first tags;
c. select a set of amendment media clips from a set of stored media files separate from the timeline, comprising, for each stored media file within the set of stored media files:
extract a set of second tags associated with the respective stored media file;
determine a tag overlap between the set of second tags and the set of first tags; and
responsive to the tag overlap exceeding a threshold value specified by the set of generation parameters:
generate a new media clip from the respective stored media file; and
add the new media clip to the set of amendment media clips;
d. add the set of amendment media clips to the media timeline; and
e. repeat steps a)-d) using the set of amendment media clips added to the media timeline as part of the subset of media clips.

12. The system of claim 11, wherein the processing system is further configured to:
compile a film file from the media timeline comprising the added set of amendment media clips;
transmit the film file to a remote processing system configured to play the film file;
receive a set of updated generation parameters from the remote processing system; and
repeat b)-d) using the set of updated generation parameters as the set of generation parameters.

13. The system of claim 12, wherein the remote processing system is configured to:
play the film file contemporaneously with receiving the film file; and
determine the set of updated generation parameters after playing the film file.

14. The system of claim 13, wherein the subset of media clips are selected based on proximity to a current temporal position within the media timeline.

15. The system of claim 14, wherein the threshold value specified by the set of generation parameters is a function of the current temporal position.

16. The system of claim 14, wherein the set of generation parameters comprises a set of tag rules associated with a generation parameter timeline, wherein the set of tag rules vary with temporal position within the generation parameter timeline, and selecting the set of amendment media clips further comprises:
determining a current tag rule based on a current temporal position within the media timeline; and
determining a clip eligibility of the respective stored media file based on the current tag rule and the second set of tags, wherein adding the respective stored media file to the set of amendment media clips is based on the clip eligibility and the tag overlap.

17. The system of claim 11, wherein adding the set of amendment media clips to the timeline comprises:
determining a temporal position in the media timeline which temporally overlaps a media clip within the subset of media clips; and
adding a clip of the set of amendment media clips to the media timeline at the temporal position.

18. The system of claim 11, wherein the processing system is further configured to repeat step e) until after the cumulative temporal length of clips in the media timeline exceeds the cumulative temporal length of the stored media files within the set of stored media files.

19. The method of claim 11, wherein the processing system is further configured to:
establish a connection with a first remote computing device;
establish a connection with a second remote computing device; and
contemporaneously:
perform b)-d) using a first set of generation parameters specific to the first remote computing device as the set of generation parameters, wherein a first film file generated from the media timeline is transmitted to the first remote computing device; and
perform b)-d) using a second set of generation parameters specific to the second remote computing device as the set of generation parameters,
wherein a second film file generated from the media timeline is transmitted to the second remote computing device.

20. The system of claim 19, wherein the first film file is distinct from the second film file.
